(19) United States
(12) Patent Application Publication
(10) Pub. No.: US 2024/0406687 A1
(43) Pub. Date: Dec. 5, 2024

(54) REAL-TIME SAMPLE AND DEVICE TRACKING

(71) Applicant: Aquatic Informatics, Inc., Vancouver (CA)

(72) Inventors: John Yap, Vancouver (CA); Jacob Burd, Vanvouver (CA); Patrick Huntly, Vancouver (CA); Steve Wood, Vancouver (CA); Scott Dorner, Vancouver (CA)

(21) Appl. No.: 18/204,498

(22) Filed: Jun. 1, 2023

(51) Int. Cl. H04W 4/38; H04W 4/02

(52) U.S. Cl. CPC H04W 4/38; H04W 4/025

(57) ABSTRACT

Disclosed are systems, methods, and devices for managing mobile devices used while collecting samples and capturing auxiliary data in the field. A sampling system may provide at-a-glance information on sample statuses, help with scheduling, and track locations of mobile devices. Locations may be obtained from lower-level software than a mobile application running on the mobile devices, so as to help ensure compliance. A mobile device may provide a mobile application that provides sample status in real-time and helps with the capture of data even without a network connection that enables uploading to a server. Because locations may be detected via satellites without requiring a network connection, the locations of devices are more reliable.

### CROSS-REFERENCE TO RELATED APPLICATIONS

None.

### BACKGROUND

Environmental conditions, including conditions of bodies of water or other natural areas, tend to change over time, and the health of the environment can improve or deteriorate due to many factors. Similarly, the quality of water (e.g., drinking water, wastewater, etc.) from taps in homes or plants can change over time as a result of many different factors, including changes at the water source, along the route, or at the destination. To monitor and take needed steps to protect the environment or otherwise maintain quality or safety, scientists and regulators test samples, such as water samples or soil samples, to identify potential issues requiring attention.

### SUMMARY

Example embodiments relate to a method implemented by a sampling system comprising one or more processors, the method comprising: obtaining an activity definition comprising sampling parameters, the sampling parameters indicative of a sample to be collected, a source location at which the sample is to be collected, and one or more specifications comprising at least one of (i) how the sample is to be collected, (ii) what is to be collected in the sample, (iii) a destination location where the sample is to be delivered following collection, and/or (iv) additional readings to be taken at the source location; transmitting, to a mobile application running on a mobile device of a user, at least a portion of the activity definition; receiving, via the mobile application, (i) a first status corresponding to the sample, wherein the first status was input into the mobile application by the user, and (ii) auxiliary data related to the activity definition; determining, based on one or more locations detected via a location device of the mobile device, a first geographic location of the mobile device corresponding to a time at which the first status was input into the mobile application; and updating a data structure in a database according to the first status and the first geographic location.

Other example embodiments relate to a sampling system comprising one or more processors, the sampling system configured to: obtain an activity definition comprising sampling parameters, the sampling parameters indicative of a sample to be collected, a source location at which the sample is to be collected, and one or more specifications comprising at least one of (i) how the sample is to be collected, (ii) what is to be collected in the sample, (iii) a destination location where the sample is to be delivered following collection, and/or (iv) additional readings to be taken at the source location; transmit, to a mobile application running on a mobile device of a user, at least a portion of the activity definition; receive, via the mobile application, (i) a first status corresponding to the sample, wherein the first status was input into the mobile application by the user, and (ii) auxiliary data related to the activity definition; determine, based on one or more locations detected via a location device of the mobile device, a first geographic location of the mobile device corresponding to a time at which the status update was input into the mobile application; and update a data structure in a database according to the first status and the first geographic location.

Yet other example embodiments relate to a mobile device comprising one or more processors configured to cause the mobile device to: receive, from a sampling system, at least a portion of an activity definition comprising sampling parameters, the sampling parameters indicative of a sample to be collected, a source location at which the sample is to be collected, and one or more specifications comprising at least one of (i) how the sample is to be collected, (ii) what is to be collected in the sample, (iii) a destination location where the sample is to be delivered following collection, and/or (iv) additional readings to be taken at the source location; generate and display, on a display device of the mobile device, a first map depicting the source location relative to a first current location of the mobile device, the first map depicting a first icon or other visual cue corresponding to a first status of the sample; receive, via one or more user interfaces of the mobile devices, at a first time, a first indication that the sample has been collected, and receiving, at the first time or at a second time, one or more field observations corresponding to the sample; detect, via a location sensor of the mobile device, one or more geographic locations corresponding to at least one of the first time and the second time; and generate and display, on the display device, a second map depicting the destination location relative to a second current location of the mobile device, the second map depicting a second icon or other visual cue corresponding to a second status of the sample.

Yet other example embodiments relate to a method implemented by a mobile device, the method comprising: receiving, from a sampling system, at least a portion of an activity definition comprising sampling parameters, the sampling parameters indicative of a sample to be collected, a source location at which the sample is to be collected, and one or more specifications comprising at least one of (i) how the sample is to be collected, (ii) what is to be collected in the sample, (iii) a destination location where the sample is to be delivered following collection, and/or (iv) auxiliary data to be obtained at the source location; generating and displaying, on a display device of the mobile device, a first map depicting the source location relative to a first current location of the mobile device, the first map depicting a first icon or other visual cue corresponding to a first status of the sample; receiving, via one or more user interfaces of the mobile devices, at a first time, a first indication that the sample has been collected, and receiving, at the first time or at a second time, one or more field observations corresponding to the sample; detecting, via a location sensor of the mobile device, one or more geographic locations corresponding to at least one of the first time and the second time; and generating and displaying, on the display device, a second map depicting the destination location relative to a second current location of the mobile device, the second map depicting a second icon or other visual cue corresponding to a second status of the sample.

These and other features, together with the organization and manner of operation thereof, will become apparent from the following detailed description and the accompanying drawings.

### BRIEF DESCRIPTION OF THE DRAWINGS

FIG. 1 is a diagram of an example system for performing potential implementations of the disclosed approach, according to some arrangements.

FIG. 2 is a diagram of example mobile devices for performing potential implementations of the disclosed approach, according to some arrangements.

FIG. 3 depicts an example management system of the mobile device of FIG. 1, according to potential embodiments.

FIG. 4 is a flowchart for potential implementations of the disclosed approach, according to some arrangements.

FIG. 5 is a flowchart for additional potential implementations of the disclosed approach, according to some arrangements.

FIGS. 6 and 7 provide example interactive user interfaces for using various functionality of the disclosed system via a sampling system, according to some arrangements.

FIGS. 8-11 provide example interactive user interfaces for using various functionality of the disclosed system via a mobile device, according to some arrangements.

### DETAILED DESCRIPTION

Collecting and testing environmental samples, such as water samples, soil samples, etc., can be critical to monitoring the health of the environment broadly or in localized areas (e.g., cities, neighborhoods, etc.), and tracking changes over time. Scientific analyses, as well as compliance with environmental laws and regulatory agency rules, require reliable tracking of samples and their testing. In various embodiments, a sampling system manages collection and processing of samples. The sampling system may provide other computing systems and mobile devices with at-a-glance views of sample statuses, and may manage location pools (e.g., different locations that a body of water or other environmental areas could be sampled) to help ensure samples are obtained from a minimum number of locations (e.g., 5 of 20 possible locations). The sampling system can also provide a portal through which users (such as users of a laboratory information management system (LIMS)) can provide, update, and track data about samples. In various examples, data may be accessible to and updatable by lab test personnel, who may be able to see that a sample has been delivered for testing by the lab. Also, the lab may further update the sample status by indicating that the lab has tested the sample. Moreover, the lab may further update the system by inputting data indicative of the results of the testing, all of which may be viewable on the calendar by a user (e.g., through the portal).

Interfacing with the sampling system may be one or more mobile devices running a mobile application that provides real-time or near real-time information on sample status and device locations. Caching of data allows users to continue to collect samples even without a network connection, particularly advantageous for remote environmental areas with reduced connectivity. Once a connection is restored, cached data can be uploaded to a server (“the cloud”). Advantageously, the location of mobile devices when samples are collected may be detected (and potentially cached), even without network connections via, for example, Global Positioning System (GPS) satellites. The status of samples continues to be tracked after the samples have been dropped off to a testing facility or other drop-off location. In various examples, a mobile application accessible to a user can, in addition to potentially collecting data indicative of the location where the sample was obtained, collect data indicative of one or more conditions at the location where the sample was contained, for example, indicative of temperature, pH, or other conditions existing at the time and/or location the sample was obtained. The disclosed approach thus provides more reliable and trustworthy collection, testing, and tracking of samples.

### Definitions

Activity definitions include sampling parameters that provide specifics on activities surrounding samples, such as the type of sample and its quantity, location to be collected from (“collection site”), timing, special instructions regarding how particular samples are to be collected, a destination (e.g., laboratory or a collection site) to which a collected sample is to be delivered, and additional readings (e.g., field observations, field analytes, sensor measurements, etc.) to be taken at the collection site or elsewhere for potentially affecting the collection site or the sample collected. Example readings include, but are not limited to, temperature, pH, chlorine residual, optical analysis (e.g., turbidity), viscosity, wind speed, etc.

Auxiliary data includes additional data obtained at a collection site, including additional sensor readings as well as device location data, and data obtained using ambient sensors such as imagers and microphones. More generally, auxiliary data may also include other data that characterizes or qualifies other data, such as data about sensors (e.g., age or status of sensors) that are used to obtain readings, and/or metadata about the readings from sensors (e.g., conditions at the time a sensor obtained a measurement). Auxiliary data may be obtained from one or more other sensors (which may be referred to as “secondary” sensors) not included in a set of one or more sensors (which may be referred to as “primary” sensors) used to obtain readings.

Visualizations include graphical icons (used interchangeably with icons) or other visual cues (e.g., different colors, acronyms or other text, thumbnails or other imagery, etc.) that provide at-a-glance functionality, indicating various parameters such as current status, locations, etc. Visualizations may change as data on which they are based change.

A source location or collection site includes a location from which a sample is to be collected, as well as the location's surroundings (e.g., within a certain radius) that are relevant to the sample being collected (e.g., a secondary upstream location of a river that is feeding a primary location from which the sample is collected).

A destination location, drop-off site, or simply destination, is a location where a sample is to be delivered following collection, such as a laboratory for testing or an intermediary drop-off site.

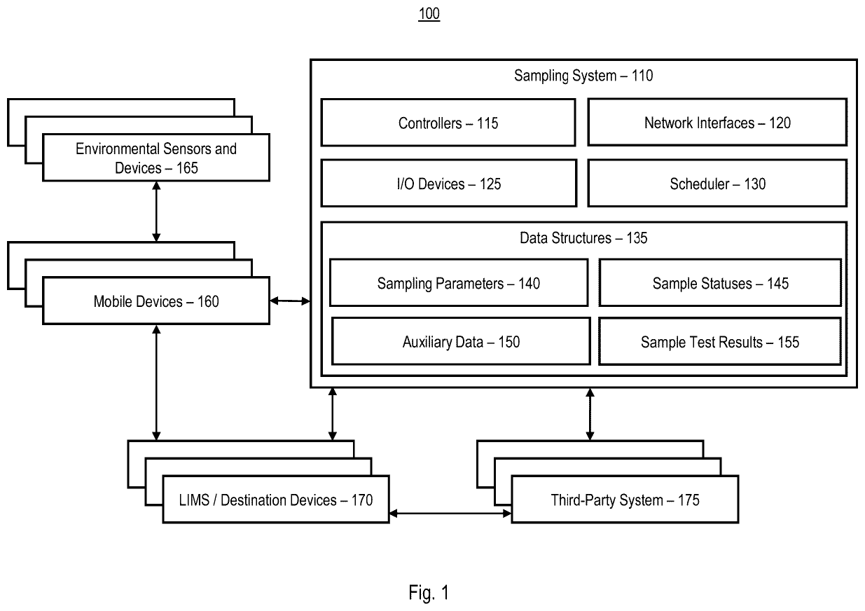

Referring to FIG. 1, depicted is a block diagram of implemented systems 100 that can be used to deploy the disclosed approach, according to various potential arrangements. Various components of system 100 may communicate with each other via telecommunication networks and protocols including, but not limited to, the internet. In example arrangements, data access may be requested, for example, via one or more application programming interfaces (APIs) that allow for API “calls” (e.g., API requests) for data exchange.

In FIG. 1, a sampling system 110 can interface with mobile devices 160 (e.g., without limitation, smartphones, tablets, laptops, or similar devices) of users who may be, for example, collecting, transporting, or testing samples. Each mobile device 160 may communicate or otherwise interface with one or more other devices, such as environmental sensors and devices 165 (e.g., a temperature gauge, pH sensor, or other device that can interface via a wire or wirelessly, such as through BLUETOOTH or Wi-Fi). Sensors may be any device that detects or otherwise senses or reports parameters of its environment, and which may, or may not, be capable of wireless communication of readings and remote controllability of functions). Each sensor 155 may include circuitry and/or a transceiver suitable for collecting and/or outputting various data (e.g., wirelessly or through wired interface).

The sampling system 110 may interface with a destination device or system 170. Example destination devices or systems 170 include a laboratory information management system (LIMS) of a laboratory that tests or otherwise processes samples, a device at an intermediary drop-off site, a scanner that can read a label on a sample to identify and track the sample, etc. The sampling system 110 may also communicate with third-party systems 175, such as systems of weather services other technical service providers or of regulators, to obtain, for example, weather data indicative of atmospheric conditions or updates to regulatory compliance rules or recommendations.

Central computing system 110 (as well as the other computing systems and devices in FIG. 1) can include one or more controllers 115, which may be, or may comprise, one or more processing units. A processing unit can include a single processor, which can have one or more cores, or multiple processors. In some embodiments, processing units can include a general-purpose primary processor as well as one or more special-purpose co-processors such as graphics processors (e.g., graphics processing units (GPUs)), digital signal processors (DSPs), or the like. The processing units can include one or more devices (e.g., random access memory (RAM), read-only memory (ROM), flash memory, hard disk storage, etc.) for storing data and/or computer code for completing and/or facilitating the various processes described herein. The memory may include non-transient volatile memory, non-volatile memory, and non-transitory computer storage media. The memory may include database components, object code components, script components, or any other type of information structure for supporting the various activities and information structures described herein. The memory may be communicatively coupled to one or more processors and may include computer code or instructions for executing one or more processes described herein. In some embodiments, some or all processing units can be implemented using customized circuits, such as application specific integrated circuits (ASICs) or field programmable gate arrays (FPGAs). In some embodiments, such integrated circuits execute instructions that are stored on the circuit itself. In other embodiments, processing units can execute instructions stored in local storage. Any type of processors in any combination can be included in controllers 105.

Central computing system 110 (as well as the other computing systems and devices in FIG. 1) can include one or more network interfaces 120, which can provide connections to various networks or to any other systems or devices via any number of wired or wireless communication protocols. In various embodiments, network interfaces 120 can include a wired interface and/or a wireless interface implementing various data communication standards such as Wi-Fi, BLUETOOTH, cellular data network standards, and/or near-field communication (NFC). The devices and systems in FIG. 1 may interface via a network that may be composed of multiple connected sub-networks or autonomous system (AS) networks, which may meet at one or more of: an intervening network (a transit network), a dual-homed gateway node, a point of presence (POP), an Internet exchange Point (IXP), and/or additional other network boundaries. The network can be a local-area network (LAN) such as a company intranet, a metropolitan area network (MAN), a wide area network (WAN), an inter network such as the Internet, or a peer-to-peer network (e.g., an ad hoc Wi-Fi peer-to-peer network). The data links between nodes in the network may be any combination of physical links (e.g., fiber optic, mesh, coaxial, twisted-pair such as Cat-5 or Cat-6, etc.) and/or wireless links (e.g., radio, satellite, microwave, etc.). The network can include carrier networks for mobile communication devices, e.g., networks implementing wireless communication protocols such as the Global System for Mobile Communications (GSM), Code Division Multiple Access (CDMA), Time Division Synchronous Code Division Multiple Access (TD-SCDMA), Long-Term Evolution (LTE), or any other such protocol including so-called generation 3G, 4G, 5G, and 6G protocols. The network can include short-range wireless links, e.g., via Wi-Fi, BLUETOOTH, BLE, or ZIGBEE, sometimes referred to as a personal area network (PAN) or mesh network. In various arrangements, the network interface controller implements one or more network protocols such as Ethernet. The network may be public, private, or a combination of public and private networks. The network interfaces may include, or may be, one or more network interface controllers that can manage data exchanges with devices in the network (sometimes referred to as a network interface port). The network interface controller can handle the physical and data link layers of the Open Systems Interconnection (OSI) model for network communication. In some arrangements, some of the network interface controller's tasks may be handled by one or more processing circuits. In various arrangements, the network interface controller is incorporated into the one or more processing circuits (e.g., as circuitry on the same chip).

Central computing system 110 (as well as the other computing systems and devices in FIG. 1) can include one or more input and output (I/O) devices 125 for interacting or interfacing with users. I/O devices 115 can be, or can include, one or more user input devices and/or one or more user output devices. User input devices can include any device (or devices) via which a user can provide signals to computing system or device that can interpret the signals as indicative of particular user interactions. In various embodiments, user input devices can include any or all of a keyboard, touch pad, touch screen, mouse or other pointing device, scroll wheel, click wheel, dial, button, switch, keypad, microphone, and so on. User output device(s) can include any device via which a computing device or system can provide information to a user. For example, user output devices can include a display to display text and images via various text and/or image generation technologies (e.g., a liquid crystal display (LCD), light-emitting diode (LED) including organic light-emitting diodes (OLED), projection system, cathode ray tube (CRT), or the like), together with supporting electronics (e.g., digital-to-analog or analog-to-digital converters, signal processors, or the like). Some embodiments can include a device such as a touchscreen that function as both input and output device. In some embodiments, other user output devices can be provided in addition to or instead of a display. Examples include indicator lights, speakers, tactile devices, printers, and so on. The I/O devices 125 can include I/O circuitry with suitable input/output ports and/or one or more interconnect buses serving as a local user interface for programming and/or data entry, retrieval, or other user interaction purposes. The I/O circuitry may provide an interface for the user to interact with various applications. For example, the I/O circuit may provide for interactivity via a keyboard, a keypad, a mouse, joystick, a touch screen, a microphone, a biometric device (e.g., a fingerprint sensor), a virtual reality headset, smart glasses, a camera suitable for taking photographic images and/or scanning QR codes, etc.

Central computing system 110 (as well as the other computing systems and devices in FIG. 1) can include one or more data structures 135 (maintained in, e.g., databases) for storing structured data about samples. Data structures may comprise data on sampling parameters 140 defined above, sample statuses (e.g., “collected”, “in progress”, “invalid”, “to be retaken”, “tested”, etc.), auxiliary data 150 as defined above, and sample test results indicative of, for example, a chemical composition, electromagnetic feature, and/or mechanical property.

Central computing system 110 may additionally include a scheduler 130 that parses data from various sources to generate activity definitions for, for example, individual samples, groups of samples, or “test groups” (e.g., a set of parameters to be determined or measurements taken in the field or at a laboratory). Scheduler 130 may generate schedules for what samples are to be collected from where based on various factors, such as an amount of time that must pass between two samples in a test group, or necessary atmospheric conditions on days of collection (based on, e.g., weather data from a third-party system 175). Schedules can be custom schedules, including dates/times with locations and a “test group” for each sample. The scheduler 130 may also associate various annotations with each activity, such as a notation indicating a special circumstance at a collection site or a particular sample.

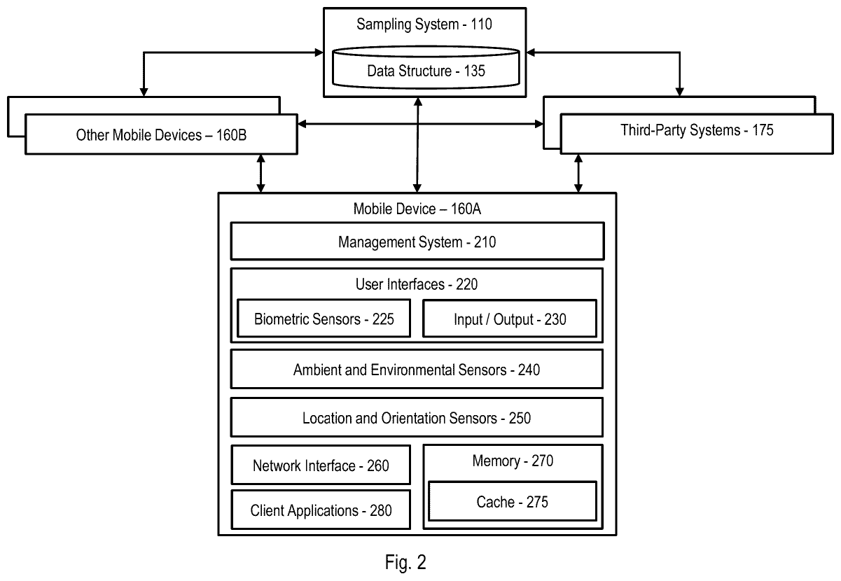

Referring to FIG. 2, a block diagram of an example arrangement enabling performance of various operations according to example embodiments is depicted. FIG. 2 depicts a sampling system 110, third-party systems 175, and mobile devices 160 (in particular, mobile device 160A and 160B, which can have the same or similar hardware and functionality though not shown in FIG. 2). Mobile device 160A (e.g., a smartphone, smart watch or other wearable device, tablet computer, laptop, or other computing device that includes a display and that is capable of running applications) may include a management system 210 (further discussed below), which may be, or may comprise, an operating system or other system software of the mobile device, or may be or may comprise other software or hardware providing control over an operating environment of the mobile device 160A. In some implementations, the management system 210 may be or may comprise, for example, iOS, Windows 10 Mobile, or Android.

Mobile device 160A may include one or more user interfaces 220, which may include one or more biometric sensors 225 (such as a fingerprint reader, a heart monitor that detects cardiovascular signals, an iris scanner, etc.). User interfaces 110 may also include I/O components 230 that provide perceptible outputs (such as displays and light sources for visually-perceptible elements, a speaker for audible elements, and haptics for perceptible signaling via touch, etc.) that capture ambient sights and sounds (such as cameras, microphones, etc.), and/or that allow the user to provide inputs (such as a touchscreen, stylus, force sensor for sensing pressure on a display screen, etc.).

Mobile device 160A may include one or more ambient and environmental sensors 240 that capture data of the surrounding of the mobile device 160A. Example ambient and environmental sensors 250 include, but are not limited to, imagers (e.g., a photo camera or other electromagnetic detectors), microphones or other sound detectors, altimeters, etc. Mobile device 160A may include one or more location and orientation sensors 250 to enable the mobile device 160A to determine its location relative to, for example, other physical objects or relative to geographic locations. Example location sensors and orientation 250 include global positioning system (GPS) devices and other navigation and geolocation devices, digital compasses, gyroscopes and other orientation sensors, as well as proximity sensors or other sensors that allow the mobile device 160A to detect the presence and relative distance of nearby objects and devices. Example location and orientation sensors 250 may detect a geographical location (e.g., latitude and longitude) in real or near-real time by, for example, using satellites or triangulation based on the coordinates of one or more cellular towers received via a communications circuit.

The mobile device 160A may include one or more network interfaces 260 that allow the mobile device 160A to communicate wirelessly or otherwise with other devices and systems. The mobile device 160A may include client applications 280, such as an internet browser and applications that interface with, for example, sampling system 110, other mobile devices 160B, third-party systems 175, or other systems and devices.

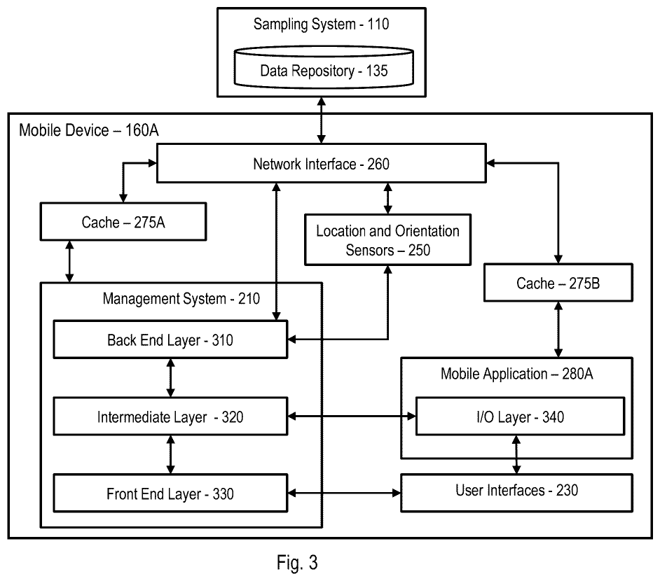

FIG. 3 depicts mobile device 160A, and in particular, components of management system 210 and the interaction thereof with components of system 100 or 200, according to potential embodiments. The management system 210 may include a back end layer 310, an intermediate layer 320, and a front end layer 330. The front end layer 330 may engage and/or exchange information with users via one or more user interfaces 230. The intermediate layer 124 may interface with, control, and/or exchange data with client applications, such as mobile application 280A, installed or otherwise executed on the mobile device 160A. And the back end layer 310 may interface and/or exchange data (e.g., via network interface 260) with sampling system 110, other mobile devices 160B, and/or third-party systems 175, directly or indirectly. Mobile application 280A may include, for example, an I/O layer 340 able to exchange data with users of mobile device 160A via user interfaces 230 and/or with management system 210 (via, e.g., intermediate layer 320).

In example embodiments, mobile device 160A may provide location data from location and orientation sensors 250 via back end layer 310, bypassing the mobile application 280. This allows, for example, the sampling system 110 to obtain location data based on what the mobile device 160A has detected, as opposed to relying on, for example, a user entry into mobile application 280. Transmission of a location may be initiated by the mobile application 280 (e.g., when a user submits a sample status update via a message or command from I/O layer 340 to intermediate layer 320. Additionally or alternatively, the mobile application 280A may transmit a status update to sampling system 110, and sampling system 110 may obtain the current location of mobile device 160A via management system 210 (e.g., via back end layer 310).

If the mobile device 160A is not currently able to access a network to transmit data (e.g., if the network interface 260 determines that no network connection is established and informs the management system 210 and/or the mobile application 280A of an absence of a network connection), data that would otherwise be transmitted to sampling system 110 may be stored locally in memory in, for example, cache 275A and/or cache 275B. Cache 275A and 275B may correspond to portions of volatile or non-volatile storage of mobile device 160A, and may be allocated or reserved by management system 210 and/or mobile application 280A in advance, or on an as-needed basis upon determination that there is no network connection.

Data in cache 275A and/or 275B may be queued up for transmission, which may be initiated (e.g., by management system 210 and/or by mobile application 280A) upon receipt of an indication from network interface 260 that a network connection has been established. In example arrangements, cache 275A may store, for example, location data to be provided to the sampling system 110, and cache 275B may store, for example, sample status updates or other user input provided by the user into the mobile application 280. In other arrangements, cache 275A and cache 275B may be combined into one cache, or may be split into additional caches.

It is noted that, each time a sensor captures data (e.g., each time the mobile application uses an imager of the device to take a photograph, each time a location sensor detects the location of the mobile device), a time stamp and/or a location stamp may be recorded to help keep better track of status updates, auxiliary data collection, etc. Once transmitted to the sampling system 110, the time stamps and/or location stamps may be stored in data structures 135.

Each system or device in FIGS. 1, 2, and 3 may include one or more processors, memories, network interfaces, and user interfaces. The memory may store programming logic that, when executed by the processor, controls the operation of the corresponding computing system or device. The memory may also store data in databases. The network interfaces allow the computing systems and devices to communicate wirelessly or otherwise. The various components of devices may be implemented via hardware (e.g., circuitry), software (e.g., executable code), or any combination thereof. Devices and components in FIGS. 1, 2, and 3 can be added, deleted, integrated, separated, and/or rearranged in various embodiments of the disclosure.

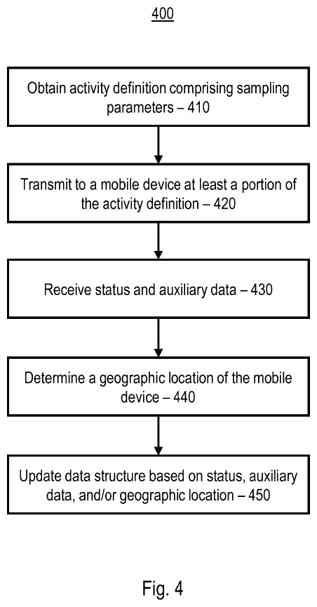

Referring to FIG. 4, disclosed is an example process 400 according to various embodiments. The various steps of process 400 may be performed by, for example, sampling system 110 (via components thereof). Process 400 may begin at step 410, which includes obtaining an activity definition comprising sampling parameters (as defined above). Portions of an activity definition may be obtained from another system (e.g., a third-party system or another database that maintains up-to-date protocols for sample collection), and certain portions may be received via user inputs (e.g., via I/O devices 125).

At step 420, process 400 includes transmitting to a mobile device (e.g., mobile device 160A) at least a portion of the activity definition. The transmission may be, for example, an in-application (“in-app”) message (e.g., a communication to the mobile application running on the mobile device) or a push notification. The portion may include what is deemed relevant or necessary, such as an identification of what sample is to be collected (e.g., water, soil, etc.), a transport vessel (e.g., 4.2 oz Nalgene bottle or other container), a storage method (e.g., store on ice in cooler), a collection site (e.g., a name of a body of water, specific coordinates, etc.), information on how the sample is to be collected (e.g., using certain equipment or tools), what is to be collected in the sample (e.g., a specified volume of water or a particular type or weight of soil), a destination location (e.g., a laboratory or drop-off site), and additional readings to be taken (e.g., field observations such as pH, temperature (e.g., air temperature or temperature of the ground or water at a particular depth, etc.). In some arrangements, the entirety of the activity definition may be transmitted to the mobile device 160A (e.g., to mobile application 280A).

An activity definition may additionally indicate that a sample to be collected is an ad hoc, or otherwise unplanned or previously unscheduled, sample collection task. For ad hoc samples, the system may support capturing a “reason”. The “reason” may indicate why the ad hoc sample is to be (or was) collected, as ad hoc sample collections are in response to an event that was not originally planned (e.g., due to an invalid or inconclusive test result, an error in sample handling, a complaint, etc.). The reason may subsequently be used for reporting purposes. In some implementations, when an ad hoc sample is being entered by a user, the user may be provided with a drop-down menu that allows the user to select a reason for the collection, such as “Customer complaint”, “Downstream” (e.g., a sample was originally taken downstream of where it should have been taken, or the sample needs to be taken downstream of where it was originally taken), “Upstream” (e.g., a sample was originally taken upstream of where it should have been taken, or the sample needs to be taken upstream of where it was originally taken), “Hydrant flushing”, “Maintenance and Repair”, “New main”, “Process”, etc. The reasons might indicate, for example, that the reason a sample is to be taken again is potential contamination.

At 430, process 400 includes receiving a status and auxiliary data. The status update and auxiliary data may be received via a mobile application running on the mobile device. The status update may indicate, for example, that a first sample in a test group has been collected, that a sample cannot be collected due to certain conditions (which may be input by the user or detected by the mobile device), or that a sample has been delivered to its destination. The auxiliary data may include, for example, sensor readings, observations, imagery (e.g., a photo), sound recordings, or other data from the collection site.

At 440, process 400 includes determining a geographic location of the mobile device. The geographic location may be determined via a location sensor of the mobile device, and may, for example, be retrieved by the sampling system 110 via management system 210. In some arrangements, the mobile device may transmit location data from a cache of the mobile device. At 450, process 400 includes updating a data structure of the sampling system 110 (e.g., sample statuses 145 and auxiliary data 150).

It is noted that in different arrangements, data may be obtained by a mobile device from a sampling system or from other mobile devices (directly or using yet other mobile devices as relays), such as when two users are at a collection site collecting samples from different sections of the collection site.

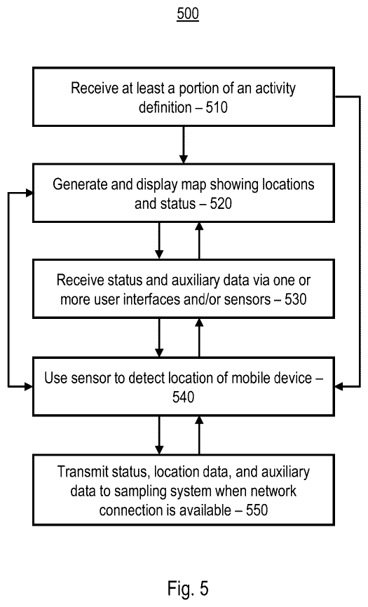

Referring to FIG. 5, disclosed is an example process 500 according to various embodiments. The various steps of process 500 may be performed by, for example, mobile device 160A (via components thereof). Process 500 includes arrows showing alternative sequences for the order in which steps are performed. For example, process 500 may proceed from step 510 to step 520 or step 540; from step 520 to step 530 or step 540; from step 530 to step 520 or step 540; or from step 540 to step 520, step 530, or step 550.

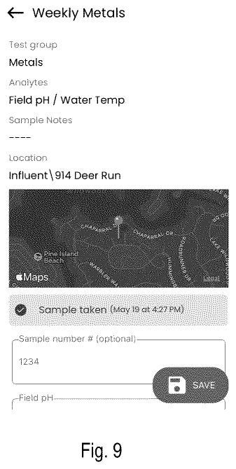

Process 500 may begin at step 510, which includes receiving at least a portion (if not all) of an activity definition. The activity definition may be received by mobile device 160A from sampling system 110. The activity definition may identify a collection site (e.g., by name, geographic coordinates, directions such as distances from landmarks or directions and distances to travel from various physical locations to reach the collection site, etc.). At 520, process 500 may include generating and displaying a map. The map may show the collection site based on a current location of the mobile device (see, e.g., FIG. 9) detected using a location sensor of the mobile device. For example, the mobile application running on the mobile device may receive a detected current location from a location sensor, and use a map application to display a geographic region that includes both the current location and the collection site. In some arrangements, the mobile application may provide a selection allowing for generation of driving or walking directions to the collection site (e.g., within the mobile application, or by launching a separate map application to show the directions).

At 530, process 500 includes receiving status and auxiliary data via one or more user interfaces and/or sensors of the mobile device. For example, the mobile application may provide a user interface (e.g., a touchscreen that may include a virtual keyboard or other graphical interfaces) that allows a user to indicate that a sample has been collected, delivered, etc. Auxiliary data may include a location of the mobile device, detected using a location sensor at 540, at the time the user changes the status of the sample. Auxiliary data may also include, for example, imagery, video, and/or audio samples taken at the collection site or the destination site. Other auxiliary data may be based on or may include, in various arrangements, a scan of a barcode, detection of other devices in the mobile device's proximity, annotations by the user regarding the sample, etc.

At 540, process 500 includes using a sensor to detect a location of the mobile device at the time the auxiliary data is obtained (e.g., at the time a status is changed, at the time a photo is taken, or at the time a barcode is scanned). At 550, the status, location data, and/or auxiliary data may be transmitted to the sampling system 110 when a network connection is available. If a network connection is not available, data may be cached as discussed above. In various arrangements, the status and auxiliary data may be provided to the sampling system by the mobile application running on the mobile device, and the location data may be provided in a manner that bypasses the mobile application (e.g., via a back end layer of a management system as discussed above).

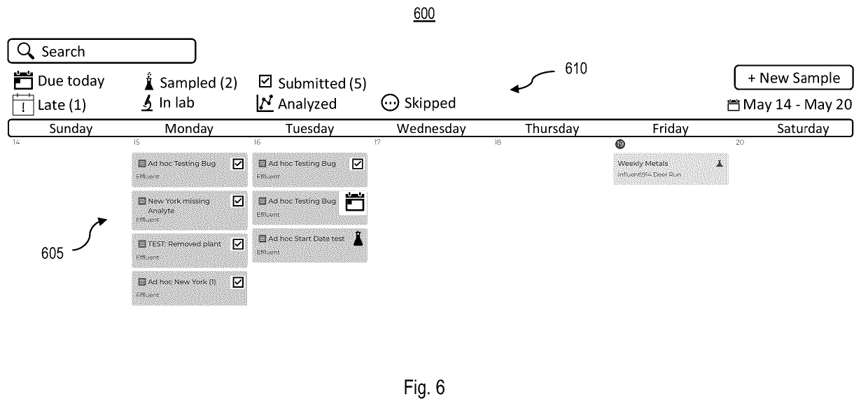

Referring to FIG. 6, the sampling system 110 may provide information (e.g., status and auxiliary data) via a portal (e.g., a mobile application or browser accessing a secure website). The user interface of FIG. 6 provides a calendar, such as a week-long calendar as shown, or other date ranges (e.g., daily, monthly, etc.). On particular days, a set of one or more sampling tasks or activities 605 (e.g., “Ad hoc Testing Bug” or “New York missing Analyte”) may be displayed for review and access to additional details upon selection. In other examples, a calendar can incorporate other functionality, such as sample timing, sampling frequency as indicated or selected by a user (e.g., four times per month and/or on each Monday of the month, for the next 15 months, etc.). In yet other examples, a missed sample can also be rescheduled by a user and connected or associated with the original (missed) sample.

The user interface of FIG. 6 provides example statuses 610 and, for each status, an icon or other visual cue which may be associated with or assigned to the activities to provide users at-a-glance updates on the sampling tasks. Status “Due today” may indicate, for example, that a sample is to be collected by a particular day; status “Late” may indicate that a task is overdue and a sample should already have been collected; status “Sampled” may indicate that a sample has been collected; status “In lab” may indicate that a sample has been delivered to a laboratory and is awaiting testing; status “Analyzed” may indicate that a test has been performed; status “Submitted” may indicate that test results have been provided to another entity such as a regulatory body; and status “Skipped” may indicate that a task has been skipped (e.g., because a sample could not be collected). At 610, each status may be followed by a number indicating how many sampling tasks being displayed on the calendar have that particular status; in FIG. 6, one task has a status of “Late”, two tasks have a status of “Sampled”, and five tasks have a status of “Submitted”. FIG. 6 also includes a search bar for searching for tasks, and an “add new sample” icon which allows for identification of another sample to be collected.

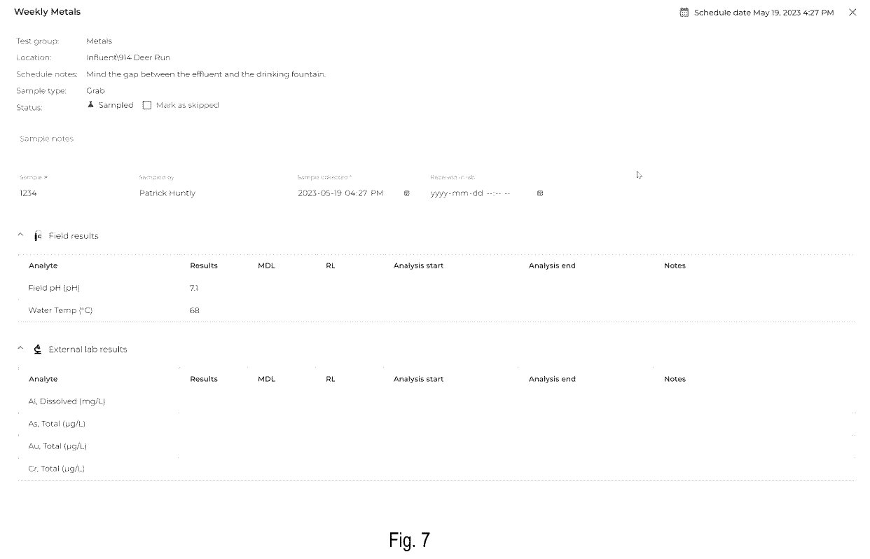

FIG. 7 shows an example activity definition titled “Weekly Metals”, which identifies a test group (“Metals”), a collection location (“Influent\914 Deer Run”), schedule notes (“Mind the gap between the effluent and the drinking fountain”), sample type (“Grab”), status (“Sampled”, with an option to “Mark as skipped”), a text box (for “Sample notes”), a sample identifier (“1234”), a name of a user who collected the sample (“Patrick Huntly”), a date and time the sample was collected (2023-05-19 4:27 PM″), and a date and time the sample was received at a laboratory, which is blank (yyyy-mm-dd --:-- --) in FIG. 7 because, consistent with the icon indicating the status is “Sampled”, this sample has been collected but has not yet been delivered to the laboratory.

FIG. 7 includes a section for additional data from the collection site (“Field results”), which shows environmental observations for “Field pH” (7.1) and “Water Temp” in Celsius (68 degrees). FIG. 7 also shows an “External lab results” section for the sample, with “AI, Dissolved (mg/L); As, Total (μg/L); Au, Total (μg/L); and Cr, Total (μg/L). No results are shown in FIG. 7 because laboratory tests are pending.

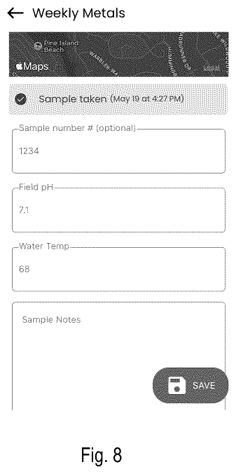

FIGS. 8 and 9 provide screenshots of user interfaces of a mobile application allowing for at-a-glance review of an activity (“Weekly Metals”) and entry of additional information. The screenshots provide an indication of status (“Sample taken (May 19 at 4:27 PM)). A user can enter, for example, a sample number, field pH, water temperature, and annotations regarding the sample. Once the information has been entered or updated, the user may select to “Save” the entries. Upon saving, if a network connection is available, the data can be uploaded to a server (e.g., the Sampling System or another computing device or system), or otherwise the data can be cached for subsequent uploading to “the cloud”. A section of a map that includes the collection site is also shown in FIG. 8.

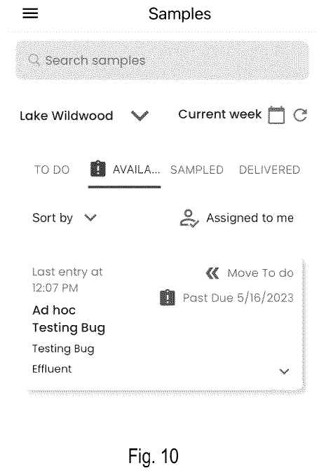

FIG. 10 provides a screenshot of another user interface that allows a user of the mobile application to search for and review activity definitions corresponding to particular samples. The user interface allows a user to search for samples via a search box, by selection of a location or test group, by date, by status, and/or by a user to whom the task has been assigned. Search results can be sorted according to various parameters using the “Sort by” pull-down menu (such as date, status, etc., not shown in FIG. 10). As other examples, a user can assign a sample to another user. In yet other examples, a user may assign a sample to himself/herself/themselves (e.g., a user may “claim” a sample as his, her, or their own) so that others will know that the user intends to collect the sample.

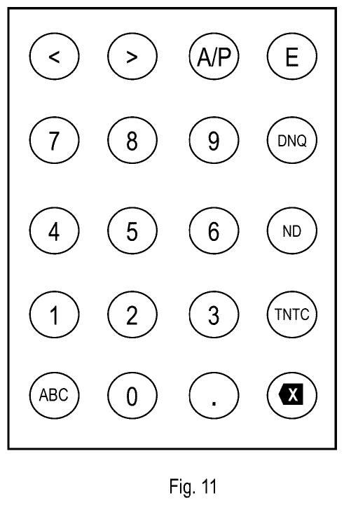

FIG. 11 depicts a specialty user interface for entering field observations via a mobile application. The inequality signs (less than “<” and greater than “>”) allow a user to provide limits for how accurate particular data is as qualification limits. For example, different analysis methods are only accurate within a range of values, and these allow a user to indicate such upper limits (via “<”) or lower limits (via “>”). For example, mercury may have a detection limit of 0.2 ng/L with a particular instrument, so if the instrument reads below 0.2 ng/L, a user may report <0.2 ng/L (less than 0.2 ng/L) because the instrument is known not to be accurate below the value of 0.2 ng/L. The “A/P” icon (“Absent/Present”) is a binary selector allowing a user to indicate an absence (“A”) of a detectable parameter (e.g., to indicate “not here”), or a presence (“P”) of a detectable parameter (e.g., to indicate “something here”).

In FIG. 11: “DNQ” represents “Detected Not Quantified” indicating a reading is above a Method Detection Limit (MDL) but lower than a Reporting Limit (RL); “E” represented “Estimate” indicating that a parameter value being submitted is an estimate; “ND” can be used to indicate a parameter is “Not Detected” or “Not Detectable”; and “TNTC” can be used to indicate a parameter is “Too Numerous To Count”. The numerals zero to 9 and the decimal point allow for entry of numeric values, and selecting “ABC” will switch from numerals to selectable letters. Selecting the “X” in the pentagon allows for a user to delete an entered character.

Sample embodiments, aspects, and implementations are disclosed below, in order to represent illustrative examples, which may be further modified, combined, constrained, etc. according to the entirety of this disclosure.

Embodiment A1: A method implemented by a sampling system comprising one or more processors, the method comprising: obtaining an activity definition comprising sampling parameters, the sampling parameters indicative of a sample to be collected, a source location at which the sample is to be collected, and one or more specifications comprising at least one of (i) how the sample is to be collected, (ii) what is to be collected in the sample, (iii) a destination location where the sample is to be delivered following collection, and/or (iv) additional readings to be taken at the source location; transmitting, to a mobile application running on a mobile device of a user, at least a portion of the activity definition; receiving, via the mobile application, (i) a first status corresponding to the sample, wherein the first status was input into the mobile application by the user, and (ii) auxiliary data related to the activity definition; determining, based on one or more locations detected via a location device of the mobile device, a first geographic location of the mobile device corresponding to a time at which the first status was input into the mobile application; and updating a data structure in a database according to the first status and the first geographic location.

Embodiment A2: The method of Embodiment A1, wherein the first geographic location is not determined based on user input.

Embodiment A3: The method of either Embodiment A1 or A2, further comprising receiving, from the mobile application or a destination computing system, a second status indicating the sample was received at the destination location, and updating the data structure according to the second status and the second geographic location.

Embodiment A4: The method of any of Embodiments A1-A3, further comprising transmitting, upon receipt of a request, at least one of the first status or the second status to a second mobile device of a second user.

Embodiment A5: The method of any of Embodiments A1-A4, wherein the auxiliary data received from the mobile application comprises image data captured using an imager of the mobile device.

Embodiment A6: The method of Embodiment A5, wherein the image data comprises a second geographic location corresponding to where the mobile device was located when the imager captured an image corresponding to the image data.

Embodiment A7: The method of Embodiment A5, further comprising determining a second geographic location based on one or more locations detected by the location device of the mobile device at a time the imager captured an image corresponding to the image data.

Embodiment A8: The method of any of Embodiments A1-A7, wherein the auxiliary data received from the mobile application comprises one or more field measurements taken at the source location.

Embodiment A9: The method of Embodiment A8, wherein the one or more field measurements were taken using a measurement device in communication with the mobile device, and wherein the auxiliary data comprises a third geographic location corresponding to at least one of (i) where the mobile device was located when the mobile application received the one or more measurements from the measurement device, or (ii) where the measurement device was located when the measurement device sensed the one or more field measurements.

Embodiment A10: The method of any of Embodiments A1-A9, wherein transmitting at least the portion of the activity definition to the mobile device comprises transmitting an in-app message to the mobile device.

Embodiment A11: The method of any of Embodiments A1-A10, wherein transmitting at least the portion of the activity definition to the mobile device comprises transmitting a push notification to the mobile device.

Embodiment A12: The method of any of Embodiments A1-A11, wherein obtaining the activity definition comprises detecting, via one or more user interfaces of the sampling system, user entries corresponding to the sample.

Embodiment A13: The method of any of Embodiments A1-A12, wherein obtaining the activity definition comprises retrieving, from a protocol database, information on the sample.

Embodiment A14: The method of any of Embodiments A1-A13, further comprising generating a first calendar comprising statuses for a plurality of activity definitions and, for each activity definition in the plurality of activity definitions, a first icon indicative of status.

Embodiment A15: The method of Embodiment A14, further comprising updating the calendar, in real time, to comprise updated statuses for the plurality of activity definitions and, for each activity definition in the plurality of activity definitions, a second icon indicative of updated statuses.

Embodiment A16: The method of any of Embodiments A1-A15, wherein the updated statuses are based at least in part on transmissions from one or more mobile devices.

Embodiment A17: The method of any of Embodiments A1-A16, further comprising importing a comma-separated values (CSV) file from a Laboratory Information Management System (LIMS), the CSV file comprising data on test results.

Embodiment A18: The method of any of Embodiments A1-A18, further comprising selecting a minimum number of locations from among a location pool of potential locations from which samples are to be collected, wherein the activity definition is indicative of the minimum number of locations.

Embodiment A19: The method of any of Embodiments A1-A18, further comprising receiving, via a user interface of a website provided to a LIMS, at least one of a first indication that particular samples have been tested or a second indication of test results.

Embodiment A20: A sampling system comprising one or more processors, the sampling system configured to: obtain an activity definition comprising sampling parameters, the sampling parameters indicative of a sample to be collected, a source location at which the sample is to be collected, and one or more specifications comprising at least one of (i) how the sample is to be collected, (ii) what is to be collected in the sample, (iii) a destination location where the sample is to be delivered following collection, and/or (iv) additional readings to be taken at the source location; transmit, to a mobile application running on a mobile device of a user, at least a portion of the activity definition; receive, via the mobile application, (i) a first status corresponding to the sample, wherein the first status was input into the mobile application by the user, and (ii) auxiliary data related to the activity definition; determine, based on one or more locations detected via a location device of the mobile device, a first geographic location of the mobile device corresponding to a time at which the first status was input into the mobile application; update a data structure in a database according to the first status and the first geographic location.

Embodiment B1. A mobile device comprising one or more processors configured to cause the mobile device to: receive, from a sampling system, at least a portion of an activity definition comprising sampling parameters, the sampling parameters indicative of a sample to be collected, a source location at which the sample is to be collected, and one or more specifications comprising at least one of (i) how the sample is to be collected, (ii) what is to be collected in the sample, (iii) a destination location where the sample is to be delivered following collection, and/or (iv) additional readings to be taken at the source location; generate and display, on a display device of the mobile device, a first map depicting the source location relative to a first current location of the mobile device, the first map depicting a first icon corresponding to a first status of the sample; receive, via one or more user interfaces of the mobile devices, at a first time, a first indication that the sample has been collected, and receiving, at the first time or at a second time, one or more field observations corresponding to the sample; detect, via a location sensor of the mobile device, one or more geographic locations corresponding to at least one of the first time and the second time; and generate and display, on the display device, a second map depicting the destination location relative to a second current location of the mobile device, the second map depicting a second icon corresponding to a second status of the sample.

Embodiment B2. The mobile device of Embodiment B1, wherein the one or more processors is further configured to transmit the one or more geographic locations detected using the location sensor to the sampling system.

Embodiment B3: The mobile device of Embodiment B2, wherein the first indication is received by the mobile device via a mobile application, and wherein the one or more geographic locations is not transmitted to the sampling system by the mobile application.

Embodiment B4: The mobile device of any of Embodiments B1-B3, wherein the one or more processors are further configured to cause the mobile device to transmit the first indication to the sampling system.

Embodiment B5: The mobile device of Embodiment B4, wherein the one or more processors are configured to, before the first indication and the one or more geographic locations are transmitted to the sampling system: determine that a network connection is not available; cache the first indication in a memory of the mobile device; and transmit the first indication from the memory to the sampling system after the network connection becomes available.

Embodiment B6: The mobile device of any of Embodiments B1-B5, wherein at least one of the first map or the second map further depicts one or more icons corresponding to one or more statuses of one or more other samples to be collected by a user of the mobile device or by one or more other users.

Embodiment B7: The mobile device of any of Embodiments B1-B6, wherein the at least the portion of the activity definition is received as an in-application notification.

Embodiment B8: The mobile device of any of Embodiments B1-B7, wherein the at least the portion of the activity definition is received in a push notification.

Embodiment B9: The mobile device of any of Embodiments B1-B8, wherein the one or more statuses and the one or more additional statuses are received from the sample system.

Embodiment B10: The mobile device of any of Embodiments B1-B9, wherein the one or more processors are further configured to cause the mobile device to connect with a measurement device to detect the one or more field measurements.

Embodiment B11: The mobile device of any of Embodiments B1-B10, wherein the one or more processors are further configured to cause the mobile device to capture, using an imager of the mobile device, image data corresponding to the source location.

Embodiment B12: The mobile device of Embodiment B11, wherein the one or more processors are further configured to cause the mobile device to transmit the image data to the sampling system.

Embodiment B13: The mobile device of Embodiment B11, wherein the one or more processors are further configured to cause the mobile device to receive, via the one or more user interfaces, at a third time, a third indication that the sample has been delivered to the destination location.

Embodiment B14: The mobile device of Embodiment B11, wherein the one or more processors are further configured to cause the mobile device to detect, via the location device of the mobile device, a third geographic location corresponding to the third time.

Embodiment B15: The mobile device of any of Embodiments B1-B14, wherein the one or more processors are further configured to cause the mobile device to generate a first calendar comprising statuses for a plurality of activity definitions and, for each activity definition in the plurality of activity definitions, a first icon indicative of status.

Embodiment B16: The mobile device of Embodiment B15, wherein the one or more processors are further configured to cause the mobile device to update the calendar, in real time, to comprise updated statuses for the plurality of activity definitions and, for each activity definition in the plurality of activity definitions, a second icon indicative of updated statuses.

Embodiment B17: The mobile device of Embodiment B16, wherein the updated statuses are based at least in part on transmissions from at least one of the sampling system or one or more mobile devices.

Embodiment B18: A method implemented by a mobile device, the method comprising: receiving, from a sampling system, at least a portion of an activity definition comprising sampling parameters, the sampling parameters indicative of a sample to be collected, a source location at which the sample is to be collected, and one or more specifications comprising at least one of (i) how the sample is to be collected, (ii) what is to be collected in the sample, (iii) a destination location where the sample is to be delivered following collection, and/or (iv) auxiliary data to be obtained at the source location; generating and displaying, on a display device of the mobile device, a first map depicting the source location relative to a first current location of the mobile device, the first map depicting a first icon corresponding to a first status of the sample; receiving, via one or more user interfaces of the mobile devices, at a first time, a first indication that the sample has been collected, and receiving, at the first time or at a second time, one or more field observations corresponding to the sample; detecting, via a location sensor of the mobile device, one or more geographic locations corresponding to at least one of the first time and the second time; and generating and displaying, on the display device, a second map depicting the destination location relative to a second current location of the mobile device, the second map depicting a second icon corresponding to a second status of the sample.

Embodiment B19: The method of Embodiment B18, further comprising transmitting the one or more geographic locations detected using the location sensor to the sampling system, wherein the first indication is received by the mobile device via a mobile application, and wherein the one or more geographic locations is not transmitted to the sampling system by the mobile application.

Embodiment B20: The method of either Embodiment B19 or B20, further comprising transmitting the first indication to the sampling system, wherein before the first indication and the one or more geographic locations are transmitted to the sampling system, the method comprises: determining that a network connection is not available; caching the first indication in a memory of the mobile device; and transmitting the first indication from the memory to the sampling system after the network connection becomes available.

Embodiment C1: A method performed by any of the above computing systems and/or computing devices.

Embodiment D1: A computing system or a computing device comprising one or more processors, the computing system or computing device configured to perform any of the above methods.

Embodiment E1: A non-transitory computer readable medium comprising instructions configured to cause a computing device or a computing system comprising one or more processors to perform any of the above methods.

Various functionality of the disclosed approach can be realized, in various embodiments, using any combination of software and hardware, such as dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa. “Software” refers generally to sequences of instructions that, when executed by processing units cause systems/devices (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing units. Software can be implemented as a single program or a collection of separate programs or program modules that interact as desired. From local storage (or non-local storage), processing units can retrieve program instructions to execute and data to process in order to execute various operations described above.

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. It is understood that all such variations are within the scope of the disclosure. Likewise, software and web implementations of the present disclosure may be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A method implemented by a sampling system comprising one or more processors, the method comprising:
obtaining an activity definition comprising sampling parameters, the sampling parameters indicative of a sample to be collected, a source location at which the sample is to be collected, and one or more specifications comprising at least one of (i) how the sample is to be collected, (ii) what is to be collected in the sample, (iii) a destination location where the sample is to be delivered following collection, and/or (iv) additional readings to be taken at the source location;
transmitting, to a mobile application running on a mobile device of a user, at least a portion of the activity definition;
receiving, via the mobile application, (i) a first status corresponding to the sample, wherein the first status was input into the mobile application by the user, and (ii) auxiliary data related to the activity definition;
determining, based on one or more locations detected via a location device of the mobile device, a first geographic location of the mobile device corresponding to a time at which the first status was input into the mobile application; and
updating a data structure in a database according to the first status and the first geographic location.

2. The method of claim 1, wherein the first geographic location is not determined based on user input.

3. The method of claim 1, further comprising receiving, from the mobile application or a destination computing system, a second status indicating the sample was received at the destination location, and updating the data structure according to the second status and the second geographic location.

4. The method of claim 1, further comprising transmitting, upon receipt of a request, at least one of the first status or the second status to a second mobile device of a second user.

5. The method of claim 1, wherein the auxiliary data received from the mobile application comprises image data captured using an imager of the mobile device.

6. The method of claim 5, wherein the image data comprises a second geographic location corresponding to where the mobile device was located when the imager captured an image corresponding to the image data.

7. The method of claim 5, further comprising determining a second geographic location based on one or more locations detected by the location device of the mobile device at a time the imager captured an image corresponding to the image data.

8. The method of claim 1, wherein the auxiliary data received from the mobile application comprises one or more field measurements taken at the source location.

9. The method of claim 8, wherein the one or more field measurements were taken using a measurement device in communication with the mobile device, and wherein the auxiliary data comprises a third geographic location corresponding to at least one of (i) where the mobile device was located when the mobile application received the one or more measurements from the measurement device, or (ii) where the measurement device was located when the measurement device sensed the one or more field measurements.

10. The method of claim 1, wherein transmitting at least the portion of the activity definition to the mobile device comprises transmitting an in-app message to the mobile device.

11. The method of claim 1, wherein transmitting at least the portion of the activity definition to the mobile device comprises transmitting a push notification to the mobile device.

12. The method of claim 1, wherein obtaining the activity definition comprises detecting, via one or more user interfaces of the sampling system, user entries corresponding to the sample.

13. The method of claim 1, wherein obtaining the activity definition comprises retrieving, from a protocol database, information on the sample.

14. The method of claim 1, further comprising generating a calendar comprising statuses for a plurality of activity definitions and, for each activity definition in the plurality of activity definitions, a first icon or other visual cue indicative of status.

15. The method of claim 14, further comprising updating the calendar, in real time, to comprise updated statuses for the plurality of activity definitions and, for each activity definition in the plurality of activity definitions, a second icon or other visual cue indicative of updated statuses.

16. The method of claim 15, wherein the updated statuses are based at least in part on transmissions from one or more mobile devices.

17. The method of claim 1, further comprising importing a comma-separated values (CSV) file from a Laboratory Information Management System (LIMS), the CSV file comprising data on test results.

18. The method of claim 1, further comprising selecting a minimum number of locations from among a location pool of potential locations from which samples are to be collected, wherein the activity definition is indicative of the minimum number of locations.

19. The method of claim 1, further comprising receiving, via a user interface of a website provided to a LIMS, at least one of a first indication that particular samples have been tested or a second indication of test results.

20. A sampling system comprising one or more processors, the sampling system configured to:
obtain an activity definition comprising sampling parameters, the sampling parameters indicative of a sample to be collected, a source location at which the sample is to be collected, and one or more specifications comprising at least one of (i) how the sample is to be collected, (ii) what is to be collected in the sample, (iii) a destination location where the sample is to be delivered following collection, and/or (iv) additional readings to be taken at the source location;
transmit, to a mobile application running on a mobile device of a user, at least a portion of the activity definition;
receive, via the mobile application, (i) a first status corresponding to the sample, wherein the first status was input into the mobile application by the user, and (ii) auxiliary data related to the activity definition;
determine, based on one or more locations detected via a location device of the mobile device, a first geographic location of the mobile device corresponding to a time at which the first status was input into the mobile application;
update a data structure in a database according to the first status and the first geographic location.
